(19) United States
(12) Patent Application Publication
(10) Pub. No.: US 2015/0317345 A1
(43) Pub. Date: Nov. 5, 2015

(54) MULTIPLE FIELDS PARALLEL QUERY METHOD AND CORRESPONDING STORAGE ORGANIZATION

(71) Applicant: NOKIA SOLUTIONS AND NETWORKS OY, Espoo, OT (FI)

(72) Inventors: Keyan LIU, Beijing (CN); Wenhui MA, Beijing (CN); Ang FAN, Beijing (CN); Yanyu MA, Beijing (CN); Haiping WANG, Jiangxi (CN)

(21) Appl. No.: 14/647,179

(22) PCT Filed: Nov. 27, 2012
(86) PCT No.: PCT/CN2012/085327

§ 371 Date: May 26, 2015

(51) Int. Cl. G06F 17/30

(52) U.S. Cl. CPC G06F 17/30333; G06F 17/30424

(57) ABSTRACT

It is provided a method, comprising associating value ranges to each of a predefined number of fields, wherein the value ranges for each of the fields are continuous; associating, for each of the fields, bijectively rowkey field values to the value ranges of the respective field, wherein the rowkey field values for each of the fields are continuous; generating rowkeys, wherein each rowkey comprises one of the rowkey field values for each of the fields, and wherein a rowkey is generated for each of the corresponding combinations of the rowkey field values; wherein the associating of the rowkey field values is further adapted to associate the rowkey field values such that for each of the fields and for each of the rowkeys: a first rowkey field value for the respective field of the respective rowkey is neighbored to a second rowkey field value for the respective field of a second rowkey of the rowkeys, and a first value range of the respective field of the respective rowkey is continuous with a second value range of the respective field of the second rowkey, wherein the rowkey field values of the respective field comprise the first and second rowkey field values, and the value ranges of the respective field comprise the first and second value ranges.

### FIELD OF THE INVENTION

The present invention relates to an apparatus, a method, a system, and a computer program product related to big data tables. More particularly, the present invention relates to an apparatus, a method, a system, and a computer program product for organizing big data tables to enable multiple fields parallel queries.

### BACKGROUND OF THE INVENTION

Abbreviations

CDR Charging Detail Record

CSP Communication Service Provider

DBMS Database Management System

I/O Input/Output

ID Identifier

KD-tree k-dimensional tree

MSISDN Mobile Subscriber International Subscriber Directory Number

R-tree Rectangular tree

RDBMS Relational Database Management System

SQL Structured Query Language

URL Unified Resource Locator

The cloud data storage and management are getting more and more attentions as a new trend of data management. In the cloud environment, large volumes of data are captured and the data set size for applications is growing at incredible pace. The processing and analyses on large scale data are data-intensive and the performance is an important issue. With the big data increases, the traditional database becomes a bottleneck to store e.g. Terabytes of data.

BigTable model was proposed by Google to scale Petabytes of data across thousands of commodity servers. There are a lot of open source implementations to simulate Google's BigTable approach, which are called BigTable-like database. BigTable-like database is a distributed, sparse and column-oriented cloud database. It aims to store huge amount of data in Terabytes or Petabytes on a cluster of low-cost commodity servers. BigTable-like key/value based cloud database supports parallelism through MapReduce and can be extended smoothly. It is designed for very large query and uses rowkey to indentify a data row and retrieve data, which is very different from the system design of RDBMS.

Although a size of each record in the telecommunication area is typically not large, the number of these records is very large. The total data size will be up to Terabytes in a specific period. On-demand reporting is a frequent operation in telecom area. For example, the user would like to query the detail report about his/her mobile phone expense. The CSP (Communication Service Provider) administrator would like to make some statistics information for specific website or user related information, such as querying the websites accessing records to generate the top-K popular web sites (K: a natural number). The current query methods and RDBMS cannot well support the on-demand reporting from the performance perspective.

Non-relational or NoSQL databases are becoming an increasingly important part of the database landscape to solve the large scale data management. BigTable-like key/value based database, HBase, has been used to store Telecom data to support large query.

In many real applications over cloud, multiple attributes of data will be accessed and analyzed intensively. To get effective statistics and specific data, query is frequently utilized. From the database perspective, the multiple attributes of data can be viewed as multiple fields. There is a key important challenge in multiple fields query on large volumes of data.

Current BigTable-like storage system cannot support multiple fields range query especially when the query is to get all or large amount of values in one or more fields. One reason for this deficiency is that current BigTable-like storage only supports single key design.

The challenge requires the proposed method to support multiple fields queries on large scale data in an efficient way. All the queries in BigTable-like database are based on the key. In current design of BigTable-like database, it supposes most of the query using a rowkey as query condition, and query using other data field will cause data scan of whole table, which leads to heavy I/O load and long query response time. According to the single key design in Bigtable-like model, the data will be scanned based on the rowkey range. The rowkey range can be a subrange of [startKey, endKey]. How to read out these rowkey ranges to cover multiple queries is a hard problem if the current BigTable cloud database is used.

To state the problem more clearly, a Telecom application is taken as an example. E.g., making a statistic report of Top-K website in mobile internet browsing, the URL and time range will be used as query condition. On the other side, the user mobile number is also a frequently-used query condition to get the detail accounting list in a time period. If the data distribution is based on the key pair of URL and time (single key design), then it will be very difficult to get the user mobile number query efficiently. Therefore, multiple-fields query is a big challenge to Big-table like database using single key design.

2 0 The work on parallel multiple fields query processing and optimization has spanned a spectrum of issues including parallel DBMS processing, adaptive parallel query processing, multi-dimensional indexing, etc.

Parallel DBMS Processing

Parallel DBMS executes queries by dividing the work and running concurrently on multiple processing nodes. Among several approaches towards designing the architecture of parallel DBMS, shared-nothing has been the most successful. In this execution model, the data is partitioned across several data nodes. A scheduler receives the query which is further scheduled for execution on the nodes containing the data. If the query touches multiple data nodes, then the data is transferred across the network to the appropriate processing nodes. In the paper [2], an approach for transforming a relational join tree into a detailed execution plan with resource allocation information, for execution on a parallel machine. The approach starts by transforming a query tree into an operator tree which is then partitioned into a forest of linear chains of pipelined operators. However the scalability of parallel DBMS is not good and parallel DBMS lacks adequate fault tolerance mechanisms.

Adaptive Parallel Query Processing

Hadoop [3], the open-source implementation of MapReduce, provides unprecedented opportunities for both research and industry. HBase provides BigTable-like capabilities on top of Hadoop. Through writing Map and Reduce functions, the data that are managed by HBase can be accessed and queried using single rowkey generating method [4]. Pig [5] is a processing environment developed by Yahoo! and along with its associate language Pig Latin tries to fill the gap between the low level Map/Reduce and the declarative SQL. It is also an implementation of parallel query. Pig Latin extends Map-reduce by defining additional SQL-like clauses which are translated in map-reduce jobs. In Pig Latin, user can define a series of steps where each step represents a single high level data manipulation. HBaseSQL [6] provides a hybrid structure with HBase and MySQL to support short-running parallel query and long-running query. The problem in HBaseSQL is that the performance of long-running query just relies on the MapReduce, which will lead the lower performance in long-running query.

Multi-Dimensional Indexing

MD-HBase [7] is a revised HBase system with the enhanced multi-dimensional indexing functionality. It use linearization techniques such as Z-ordering to transform multi-dimensional data into a one dimensional space and uses a range partitioned HBase as the storage backend. The indexing layer assumes that the underlying data storage layer stores the items sorted by their key and range-partitions the key space. EEMINC [8] is a multi-dimensional index for cloud computing system. It uses the combination of R-tree and KD-tree to organize data records and offer fast query processing and efficient index maintenance. This approach can process typical multi-dimensional queries including point queries and range queries efficiently. The disadvantage of multi-dimensional indexing approach is that it may bring extra overhead for indexing.

References:

[1] http://www.orafaq.com/wiki/Parallel_Query_FAQ.

[2] A Tree-Decomposition Approach to Parallel Query Optimization (1993).

[3] http://hadoop.apache.org.

[4] http://hbase.apache.org/book.html.

[5] C. Olston, B. Reed, U. Srivastava, R. Kumar, and A. Tomkins. Pig Latin: a not so-foreign language for data processing. Proceedings of the 2008 ACM SIGMOD international conference on Management of data, pages 1099-1110, New York, N.Y., USA, 2008.

[6] Adrian Daniel Popescu, Debabrata Dash, Verena Kantere, etc. Adaptive query execution for data management in the cloud. In Proceedings of the second international workshop on Cloud data management (CloudDB '10). ACM, New York, N.Y., USA, 17-24.

[7] Shohji Nishimura, Sudipto Das, Divyakant Agrawal, etc. MD-HBase: A scalable multi-dimensional data infrastructure for location aware services. MDM 2011.

[8] Xiangyu Zhang, Jing Ai, Zhongyuan Wang, etc. An efficient multi-dimensional index for cloud data management. Cloud Workshop 2009.

### SUMMARY OF THE INVENTION

It is an object of the present invention to improve the prior art. In detail, it is an object to improve the performance for multiple field queries.

According to a first aspect of the invention, there is provided an apparatus, comprising storage means adapted to store sets of data in sections and to store rowkeys and value ranges, wherein each set of data comprises a predefined number of fields, wherein each field of each set has a value; the rowkeys are bijectively associated to the sections; each rowkey comprises a respective rowkey field value for each of the fields, and the rowkey field values for each of the fields are continuous; each of the value ranges is associated to at least one of the fields; the rowkey field values of each of the fields are bijectively associated to the value ranges associated to the respective field; for each of the fields and for each of the sections: a first rowkey field value for the respective field of the respective section is neighbored to a second rowkey field value for the respective field of a second section of the sections, and a first value range of the respective field in the respective section is continuous with a second value range of the respective field in the second section, wherein the rowkey field values of the respective field comprise the first and second rowkey field values, and the value ranges of the respective field comprise the first and second value ranges; the storage means is adapted to store in each of the sections only those of the sets of data in which the value of each field is in the respective value range associated to the corresponding rowkey field value comprised by the rowkey associated to the respective section.

In the apparatus, the predefined number of fields may be three or more.

The apparatus may further comprise evaluating means adapted to evaluate a value of each field of a first set of data of the sets of data; storing range determining means adapted to determine, for each field of the first set of data, the value range of the respective field, such that the value of the respective field in the first set of data falls into the determined value range; selecting means adapted to select for each field a respective rowkey field value associated to the determined value range; compiling means adapted to compile a first rowkey of the rowkeys, wherein the first rowkey comprises the selected rowkey field values; wherein the storage means may be adapted to store the first set of data in a first section of the sections, wherein the first section may be associated to the compiled first rowkey.

The apparatus may further comprise mapping means adapted to map the first rowkey to a first rowkey number of rowkey numbers, wherein the rowkey numbers may be continuous and bijectively associated to the rowkeys, and first identifying means adapted to identify the first section based on the first rowkey number; wherein the storage means may be adapted to store the first set of data in the first section identified by the identifying means.

The apparatus may further comprise query range determining means adapted to determine, for each field of a query related to at least one field, one or more of the value ranges associated to the at least one field; mapping means adapted to map the one or more determined value ranges to the associated one or more rowkey field values; rowkey determining means adapted to determine those one or more of the rowkeys which comprise the mapped rowkey field values; section determining means adapted to determine those one or more of the sections which are associated to the determined one or more rowkeys; querying means adapted to perform the query in the determined one or more sections only.

The apparatus may further comprise range identifying means adapted to identify a continuous range of rowkey numbers mapped to the determined rowkeys if more than one rowkey is determined; wherein the querying means may be adapted to perform a single query in all the sections associated to the continuous range of rowkey numbers.

In the apparatus, more than one section may be determined and the determined sections may comprise a second section and a third section different from the second section, and wherein the querying means may be adapted to perform the query in the second section in parallel to the query in the third section.

In the apparatus, the sections may be provided in a single computer, or in different nodes of a cluster of computers.

According to a second aspect of the invention, there is provided an apparatus, comprising storage equipment adapted to store sets of data in sections and to store rowkeys and value ranges, wherein each set of data comprises a predefined number of fields, wherein each field of each set has a value; the rowkeys are bijectively associated to the sections; each rowkey comprises a respective rowkey field value for each of the fields, and the rowkey field values for each of the fields are continuous; each of the value ranges is associated to at least one of the fields; the rowkey field values of each of the fields are bijectively associated to the value ranges associated to the respective field; for each of the fields and for each of the sections: a first rowkey field value for the respective field of the respective section is neighbored to a second rowkey field value for the respective field of a second section of the sections, and a first value range of the respective field in the respective section is continuous with a second value range of the respective field in the second section, wherein the rowkey field values of the respective field comprise the first and second rowkey field values, and the value ranges of the respective field comprise the first and second value ranges; the storage equipment is adapted to store in each of the sections only those of the sets of data in which the value of each field is in the respective value range associated to the corresponding rowkey field value comprised by the rowkey associated to the respective section.

In the apparatus, the predefined number of fields may be three or more.

The apparatus may further comprise evaluating processor adapted to evaluate a value of each field of a first set of data of the sets of data; storing range determining processor adapted to determine, for each field of the first set of data, the value range of the respective field, such that the value of the respective field in the first set of data fails into the determined value range; selecting processor adapted to select for each field a respective rowkey field value associated to the determined value range; compiling processor adapted to compile a first rowkey of the rowkeys, wherein the first rowkey comprises the selected rowkey field values; wherein the storage equipment may be adapted to store the first set of data in a first section of the sections, wherein the first section may be associated to the compiled first rowkey.

The apparatus may further comprise mapping processor adapted to map the first rowkey to a first rowkey number of rowkey numbers, wherein the rowkey numbers may be continuous and bijectively associated to the rowkeys, and first identifying processor adapted to identify the first section based on the first rowkey number; wherein the storage equipment may be adapted to store the first set of data in the first section identified by the identifying processor.

The apparatus may further comprise query range determining processor adapted to determine, for each field of a query related to at least one field, one or more of the value ranges associated to the at least one field; mapping processor adapted to map the one or more determined value ranges to the associated one or more rowkey field values; rowkey determining processor adapted to determine those one or more of the rowkeys which comprise the mapped rowkey field values; section determining processor adapted to determine those one or more of the sections which are associated to the determined one or more rowkeys; querying processor adapted to perform the query in the determined one or more sections only.

The apparatus may further comprise range identifying processor adapted to identify a continuous range of rowkey numbers mapped to the determined rowkeys if more than one rowkey is determined; wherein the querying processor may be adapted to perform a single query in all the sections associated to the continuous range of rowkey numbers.

In the apparatus, more than one section may be determined and the determined sections may comprise a second section and a third section different from the second section, and wherein the querying processor may be adapted to perform the query in the second section in parallel to the query in the third section.

In the apparatus, the sections may be provided in a single computer, or in different nodes of a cluster of computers.

According to a third aspect of the invention, there is provided an apparatus, comprising value range associating means adapted to associate value ranges to each of a predefined number of fields, wherein the value ranges for each of the fields are continuous; rowkey field value associating means adapted to associate, for each of the fields, bijectively rowkey field values to the value ranges of the respective field, wherein the rowkey field values for each of the fields are continuous; rowkey generation means adapted to generate rowkeys, wherein each rowkey comprises one of the rowkey field values for each of the fields, and wherein a rowkey is generated for each of the corresponding combinations of the rowkey field values; wherein the rowkey field value associating means is further adapted to associate the rowkey field values such that for each of the fields and for each of the rowkeys: a first rowkey field value for the respective field of the respective rowkey is neighbored to a second rowkey field value for the respective field of a second rowkey of the rowkeys, and a first value range of the respective field of the respective rowkey is continuous with a second value range of the respective field of the second rowkey, wherein the rowkey field values of the respective field comprise the first and second rowkey field values, and the value ranges of the respective field comprise the first and second value ranges.

The apparatus may further comprise rowkey associating means adapted to associate bijectively the rowkeys to sections of a storage device.

According to a fourth aspect of the invention, there is provided an apparatus, comprising value range associating processor adapted to associate value ranges to each of a predefined number of fields, wherein the value ranges for each of the fields are continuous; rowkey field value associating processor adapted to associate, for each of the fields, bijectively rowkey field values to the value ranges of the respective field, wherein the rowkey field values for each of the fields are continuous; rowkey generation processor adapted to generate rowkeys, wherein each rowkey comprises one of the rowkey field values for each of the fields, and wherein a rowkey is generated for each of the corresponding combinations of the rowkey field values; wherein the rowkey field value associating processor is further adapted to associate the rowkey field values such that for each of the fields and for each of the rowkeys: a first rowkey field value for the respective field of the respective rowkey is neighbored to a second rowkey field value for the respective field of a second rowkey of the rowkeys, and a first value range of the respective field of the respective rowkey is continuous with a second value range of the respective field of the second rowkey, wherein the rowkey field values of the respective field comprise the first and second rowkey field values, and the value ranges of the respective field comprise the first and second value ranges.

The apparatus may further comprise rowkey associating processor adapted to associate bijectively the rowkeys to sections of a storage device.

According to a fifth aspect of the invention, there is provided a system, comprising a partitioner apparatus according to the third aspect; and a storage apparatus according to the first aspect; wherein the storage device of the partitioner apparatus comprises the storage means of the storage apparatus; and the rowkeys and value ranges of the partitioner apparatus are stored as the rowkeys and the value ranges by the storage means of the storage apparatus.

According to a sixth aspect of the invention, there is provided a system, comprising a partitioner apparatus according to the fourth aspect; and a storage apparatus according to the second aspect; wherein the storage device of the partitioner apparatus comprises the storage equipment of the storage apparatus; and the rowkeys and value ranges of the partitioner apparatus are stored as the rowkeys and the value ranges by the storage equipment of the storage apparatus.

According to a seventh aspect of the invention, there is provided a method, comprising storing sets of data in sections and storing rowkeys and value ranges, wherein each set of data comprises a predefined number of fields, wherein each field of each set has a value; the rowkeys are bijectively associated to the sections; each rowkey comprises a respective rowkey field value for each of the fields, and the rowkey field values for each of the fields are continuous; each of the value ranges is associated to at least one of the fields; the rowkey field values of each of the fields are bijectively associated to the value ranges associated to the respective field; for each of the fields and for each of the sections: a first rowkey field value for the respective field of the respective section is neighbored to a second rowkey field value for the respective field of a second section of the sections, and a first value range of the respective field in the respective section is continuous with a second value range of the respective field in the second section, wherein the rowkey field values of the respective field comprise the first and second rowkey field values, and the value ranges of the respective field comprise the first and second value ranges; the storaging is adapted to store in each of the sections only those of the sets of data in which the value of each field is in the respective value range associated to the corresponding rowkey field value comprised by the rowkey associated to the respective section.

In the method, the predefined number of fields may be three or more.

The method may further comprise evaluating a value of each field of a first set of data of the sets of data; determining, for each field of the first set of data, the value range of the respective field, such that the value of the respective field in the first set of data falls into the determined value range; selecting for each field a respective rowkey field value associated to the determined value range; compiling a first rowkey of the rowkeys, wherein the first rowkey comprises the selected rowkey field values; wherein the storing may be adapted to store the first set of data in a first section of the sections, wherein the first section may be associated to the compiled first rowkey.

The method may further comprise mapping the first rowkey to a first rowkey number of rowkey numbers, wherein the rowkey numbers may be continuous and bijectively associated to the rowkeys, and identifying the first section based on the first rowkey number; wherein the storing may be adapted to store the first set of data in the identified first section.

The method may further comprise determining, for each field of a query related to at least one field, one or more of the value ranges associated to the at least one field; mapping the one or more determined value ranges to the associated one or more rowkey field values; determining those one or more of the rowkeys which comprise the mapped rowkey field values; determining those one or more of the sections which are associated to the determined one or more rowkeys; performing the query in the determined one or more sections only.

The method may further comprise identifying a continuous range of rowkey numbers mapped to the determined rowkeys if more than one rowkey is determined; wherein the query is performed as a single query in all the sections associated to the continuous range of rowkey numbers.

In the method, more than one section may be determined and the determined sections may comprise a second section and a third section different from the second section, and wherein the query in the second section may be performed in parallel to the query in the third section.

In the method, the sections may be provided in a single computer, or in different nodes of a cluster of computers.

According to an eighth aspect of the invention, there is provided a method, comprising associating value ranges to each of a predefined number of fields, wherein the value ranges for each of the fields are continuous; associating, for each of the fields, bijectively rowkey field values to the value ranges of the respective field, wherein the rowkey field values for each of the fields are continuous; generating rowkeys, wherein each rowkey comprises one of the rowkey field values for each of the fields, and wherein a rowkey is generated for each of the corresponding combinations of the rowkey field values; wherein the associating of the rowkey field values is further adapted to associate the rowkey field values such that for each of the fields and for each of the rowkeys: a first rowkey field value for the respective field of the respective rowkey is neighbored to a second rowkey field value for the respective field of a second rowkey of the rowkeys, and a first value range of the respective field of the respective rowkey is continuous with a second value range of the respective field of the second rowkey, wherein the rowkey field values of the respective field comprise the first and second rowkey field values, and the value ranges of the respective field comprise the first and second value ranges.

The method may further comprise associating bijectively the rowkeys to sections of a storage device.

According to a ninth aspect of the invention, there is provided a method, comprising a partitioner method according to the eighth aspect; and a storage method according to the seventh aspect; wherein the storage device of the partitioner method comprises a storage means or a storage equipment to which the storage method is applied; and the rowkeys and value ranges of the partitioner method are stored as the rowkeys and the value ranges by the storage means or storage equipment to which the storage method is applied.

The methods of the seventh to ninth aspects may be methods of big-table like storage.

According to a tenth aspect of the invention, there is provided a computer program product comprising a set of instructions which, when executed on an apparatus, is configured to cause the apparatus to carry out the method according to any one of the seventh to ninth aspects. The computer program product may be embodied as a computer-readable medium.

According to embodiments of the invention, at least the following advantages are achieved:

Compared with the three conventional approaches discussed hereinabove, the method according to embodiments of the invention is a simple and effective solution with less effort than parallel DBMS.

It scales better than parallel DBMS with increasing data volumes.

Parallel multiple fields query may have better performance than according to the adaptive parallel query processing approach, since the adaptive parallel query processing approach just uses basic storage functionality of the BigTable.

The method according to embodiments of the invention distributes data records reasonably to guarantee the load balance. In contrast to that, multi-dimensional indexing approach has problems in load balancing.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein

FIG. 1 shows a three-dimensional rowkey value space;

FIG. 2 shows that a three-dimensional value space can be seen as sets of planes;

FIG. 3 shows a multiple fields query mapped to a linear representation of the rowkeys according to an embodiment of the invention;

FIG. 4 shows the data partition by the rowkey algorithm according to an embodiment of the invention;

FIG. 5 shows a parallel query for field f₂ according to an embodiment of the invention;

FIG. 6 shows a parallel query for field f₁ according to an embodiment of the invention;

FIG. 7 shows a parallel query for field f₃ according to an embodiment of the invention;

FIG. 8 shows a parallel query for multiple fields [f₁, f₂, f₃] according to an embodiment of the invention;

FIG. 9 shows a rowkey partition and data query in rowkey level according to an embodiment of the invention;

FIG. 10 shows a range query in parallel according to an embodiment of the invention;

FIG. 11 shows an apparatus according to an embodiment of the invention;

FIG. 12 shows a method according to an embodiment of the invention;

FIG. 13 shows an apparatus according to an embodiment of the invention; and

FIG. 14 shows a method according to an embodiment of the invention.

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

Embodiments of this invention are related to the field of data management in conjunction with data-intensive computing.

The field of technology covers e.g. one or more of the following aspects:
Parallel query on large scale data;
Multiple fields query based on BigTable-like system; and
Query method to enable near real-time response.

In BigTable-like database, data partition is based on key-based data distribution of all data-sets in the cluster. Every row will be assigned a key called rowkey, and rowkey is the unique identification used to access the data record. The rowkey corresponds to the primary key in RDBMS and are arranged in an ascending order, and they are continuous in value. The rowkeys in a table may be split into multiple row ranges, and a group of sorted row ranges may represent a whole table. As a unique way to find the rowkey range and then access the data, rowkey is crucial for storing and querying data. Its generating method should be sophisticated, especially for the query requirements to multiple fields.

Embodiments of the invention include a data partition method. Some embodiments of the invention include a corresponding query decomposition method. The data partition method is expressed by the rowkey generating method in BigTable-like storage system. To ensure the efficiency of parallel multiple fields query, in some embodiments of the invention parallel query decomposition method is implemented based on the data partition approach.

Method according to embodiments of the invention make data partition with a rowkey generating algorithm, which distributes data over one or more cluster nodes based on rowkey values. Towards multiple attributes of data, the rowkey generating method creates a multi-dimensional mapping to the data, and each dimension is corresponding to one field of data. The rowkey value space is partitioned by the rowkey generating method, which can distribute the query over rowkey ranges and improve the query efficiency.

The rowkey generating method according to some embodiments of the invention includes:
Assuming there are N query fields, f₁, f₂, . . . , fₙ;
The N fields for queries are mapped to N dimensional space;
The value of each dimension is continuous and has a specific range;
The rowkey is unique when the N fields are all given, and it has a unique position in N dimensional space;
The data partition is based on the rowkey distribution.

In some embodiments of the invention, the real value of rowkey is converted to one-dimensional space although, logically, it is a multiple dimensional mapping.

Based on the rowkey generating method according to some embodiments of the invention, a query decomposition method according to some embodiments of the invention supports multi-fields query efficiently. The approach according to some embodiments of the invention can be expressed as follows:
For a specific query, one rowkey range or several continuous ranges is got based on the rowkey generating method
The continuous rowkey is processed by one or several query request
If all the query fields are given, the query will be mapped to a point in the multiple dimension space
If less than all fields of query are given or values of fields are given in range, the query will mapped in a multiple sections of N dimensional value space. This applies e.g. to all range queries.

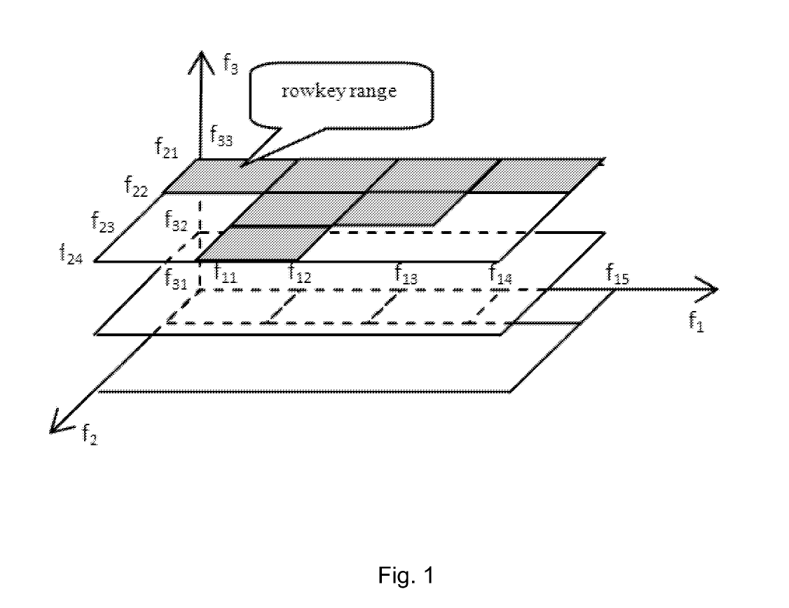

To state the method more clearly, three fields query is taken as an example as follows. Each data record contains three fields: f₁, f₂ and f₃. This rowkey method can map data into a three-dimension value space, which is shown in FIG. 1.

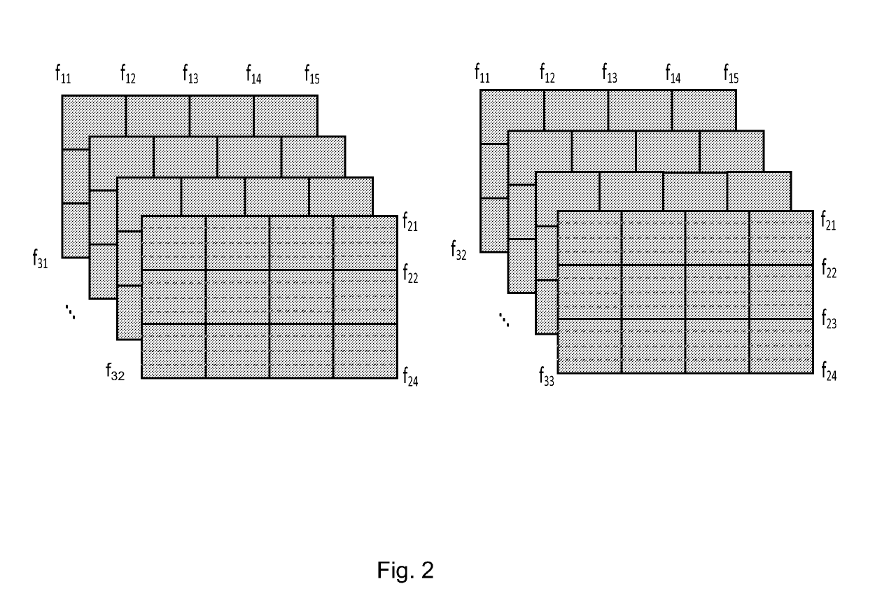

As shown in FIG. 2, the three-dimension value space is constructed by many plane sets (two-dimensions). Each plane is partitioned into some rectangles, and each rectangle represents a rowkey range. Then the three-dimension space is decomposed into many rectangles, and these rectangles contain rowkey values in order.

Through the rowkey generating method according to embodiments of the invention, data is distributed into different rowkey range which avoids the hot spot and frequent range splitting. Furthermore, the rowkey method just generates necessary rowkey ranges according to the input fields. So query for multiple fields just needs to scan necessary rowkey ranges, which is much better than whole table scan usually used in BigTable-like database.

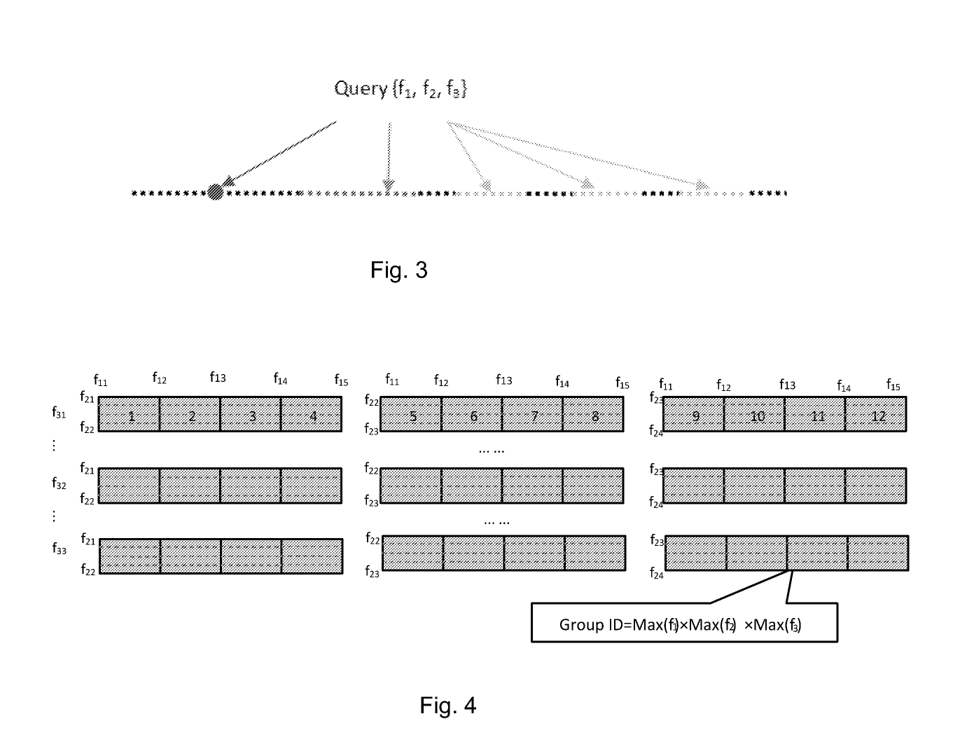

Finally, in some embodiments, the three dimension rowkey value space is transformed to one dimension (see FIG. 3), and the rowkeys are the points in the line, and they are continuous in value. Accordingly, a multiple fields query may also be transformed to locate rowkey value(s) in the line, such that the query will address a point, or one or more continuous ranges.

According to embodiments of the invention, rowkey is used to make data partition and data querying in BigTable-like database. In order to support multiple fields query, the target fields of query are involved in the rowkey generating. A Rowkey generating method according to embodiments of the invention is designed as follows:

rowkey(f₁, f₂, . . . , fₙ)=(sum(fₙ)+rowkey(f₁, f₂))n≦3 (1)

Where:

$$\begin{matrix}[ ( sum ( f {1}_{n} ) = Max ( {f}_{1} ) \times Max ( {f}_{2} ) \times … \times Max ( {f}_{n - 1} ) \times Max ( {f}_{n} ) , n \geq 3 & ( 2 ) \\ rowkey ( {f}_{1} , {f}_{2} ) = ( ⌊ \frac{{f}_{2}}{\frac{Max ( {f}_{2} )}{{F}_{2}}} ⌋ \times {F}_{1} + ⌊ \frac{{f}_{1}}{\frac{Max ( {f}_{1} )}{{F}_{1}}} ⌋ ) \times \frac{Max ( {f}_{1} ) \times Max ( {f}_{2} )}{{F}_{1} \times {F}_{2}} + {f}_{2} \% \frac{Max ( {f}_{2} )}{{F}_{2}} \times \frac{Max ( {f}_{1} )}{{F}_{1}} + {f}_{1} \% \frac{Max ( {f}_{2} )}{{F}_{1}} & ( 3 )\end{matrix}$$

1) rowkey(f₁, f₂, . . . , fₙ): it is the rowkey and it can be represented as a function of field f₁, f₂, . . . , fₙ;
2) fᵢ (i=1, 2, . . . , n): it represents the value in a field i of record. Max(fᵢ) is the maximum value of fᵢ;
3) Fᵢ, i=1, 2, . . . n): it is a constant value and represents the number of splitting the value space of f₁ and f₂. Each value split contains continuous value and is represented by [start value, end value).

According to the rowkey generating method, the rowkey maybe a unique value, continuous range value, or discrete range value, which depends on the values of f₁, f₂ and f₃.

Exemplarily supposing the rowkey covers the fields of f₁, f₂ and f₃, the cases of the rowkey value can be explained as follows:

This rowkey algorithm maps the data fields into a rowkey value, and all values are continuous. Furthermore, the rowkey algorithm may divide the value space into some groups, in each group the rowkey values are continuous and group IDs are also continuous. The example mentioned hereinabove is used here, and FIG. 4 shows the result of data partition, wherein each rectangle represents a group. For example, one group may comprise the sections noted by 1 to 4, which form the upper left rectangle.

Based on the data partition mentioned above, according to some embodiments of the invention the data records may be read from different regions and different rows. The reading may be performed in parallel. The parallel query is well supported, especially for a range query. If the query is about one or more fields of record in a range, the query will involve more than one rowkey range.

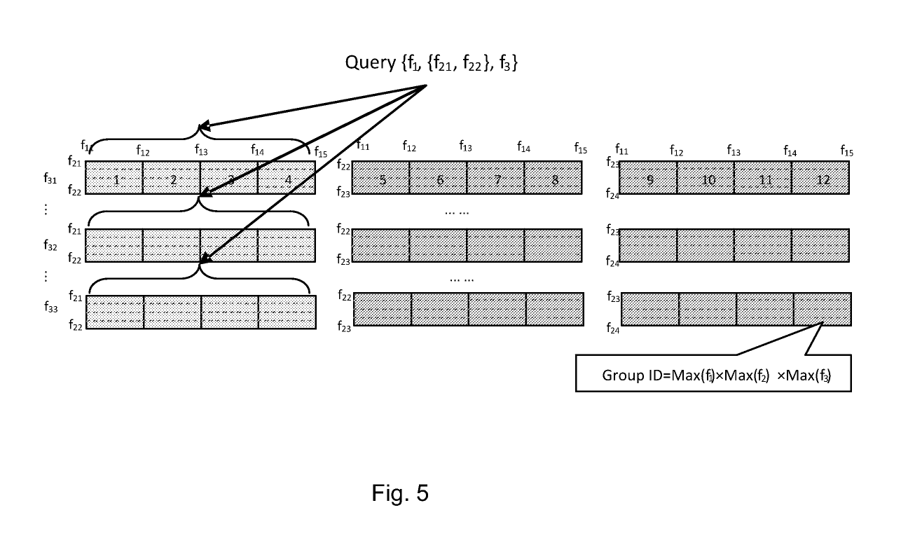

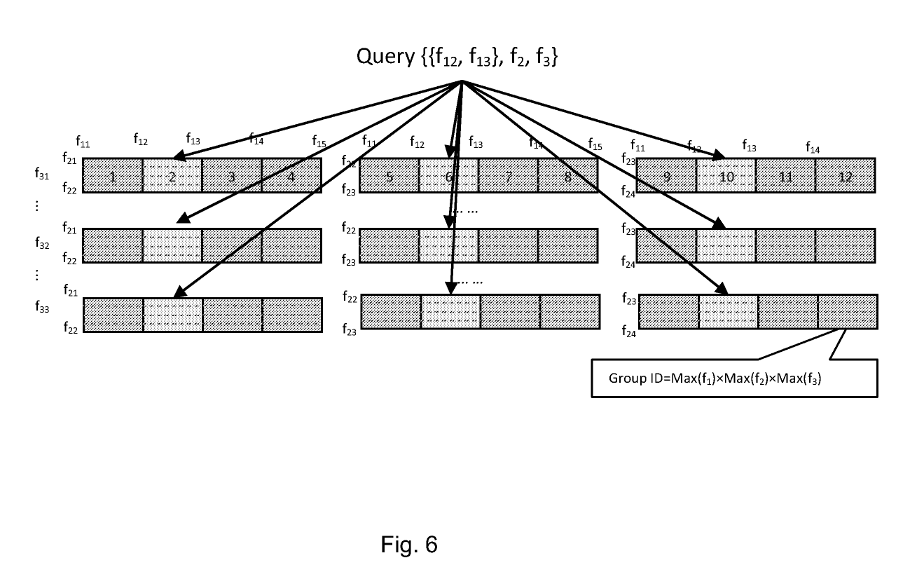

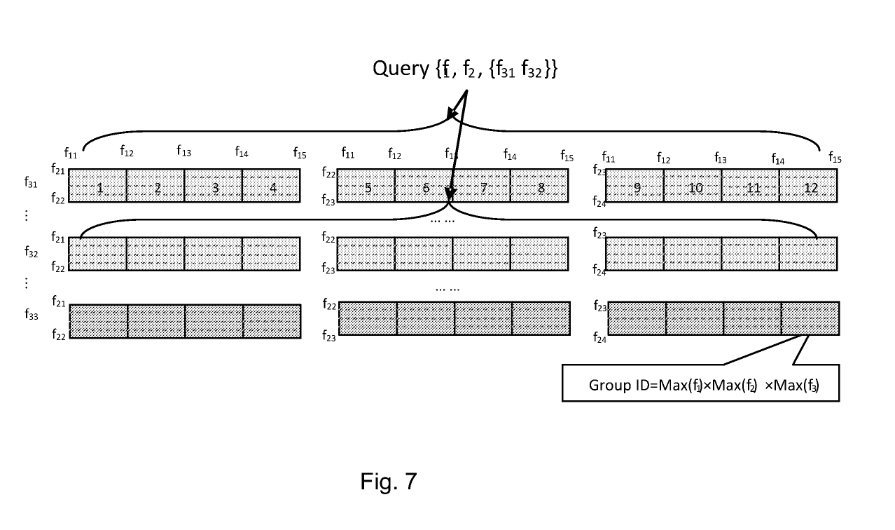

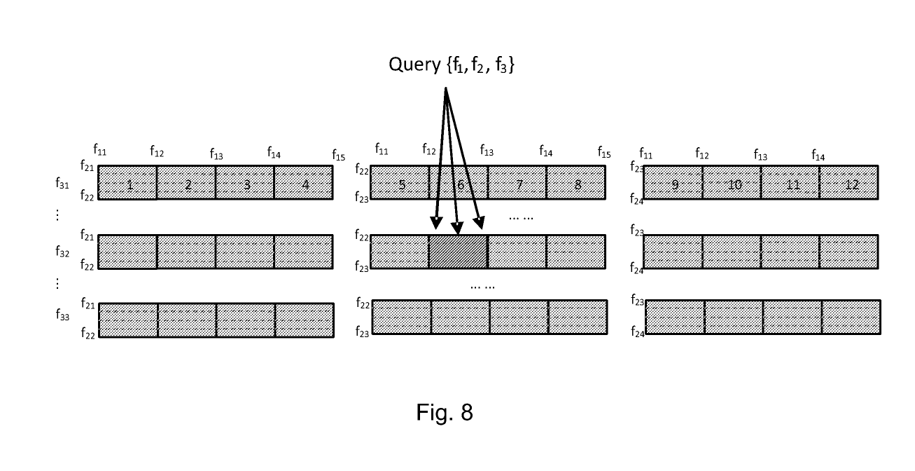

As shown in FIG. 5 and FIG. 6, data are distributed in many rowkey ranges. From the perspective of parallel data processing, the data records can be read from different rowkey ranges in parallel. In the following, three conditions for parallel query according to the query fields are exemplified; the example mentioned hereinabove is also used here.
If f1 and f3 are not given in a query and the value of f2 falls into range of f21 to f22, rowkey value will be a continuous function of f2. So the parallel query may be implemented by scanning several group sets, and in each set the group ID is sequential (as shown in FIG. 5).
If f₂ and f₃ are not given in a query and the value of f₁ falls into range of f₁₂ to f₁₃, query will be mapped to some groups whose group ID is discrete and parallel query may be implemented by just scanning these groups (see FIG. 6).
If f₁ and f₂ are not given in a query and the value of f₃ falls into range of f₃₁ to f₃₂, query will be mapped to some planes (two-dimensional). In each plane, group ID is sequential (see FIG. 7). So parallel query may be performed by scanning planes or groups.
If all of f1, f2, and f3 are given, the multiple fields query will be mapped to one point or several points in one dimension, which is shown in FIG. 8.

If no field is specified, then the query will be a full table scan.

The method according to embodiments of the invention may be used in telecom domain to store customer data record and make range query.

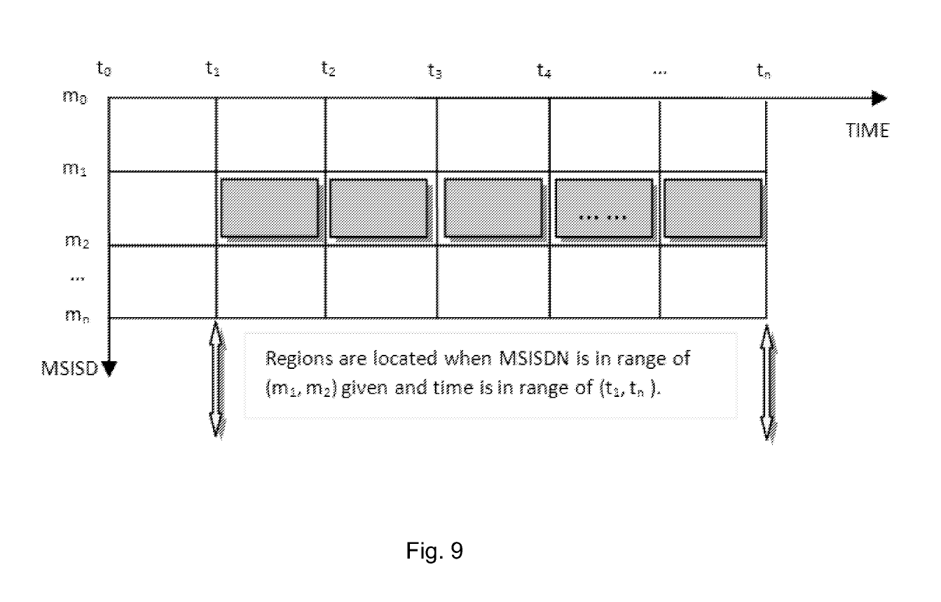

In the exemplary embodiment, the data objects are small in size and the fields of record include MSISDN (user ID), time and URL accessed, up/down link message volume and so on. HBase is used to store data records, and each record is putted in a row in HBase. The fields of record are corresponding to the columns of HBase. In our use case, the fields of time and MSISDN are involved into the rowkey generating and they are also the query targets. According to the rowkey method, the data records are distributed in different HBase regions (rowkey range) shown in FIG. 9. And each region contains continuous rowkey values.

Consider an exemplary query case: the query is for MSISDN range (m₁, m₂) and time range (t₁, tₙ). Through the rowkey generating method, the StartKey and EndKey can be got using (m₁, t₁) and (m₂, tₙ). Then a list of regions that include the records with specific MSISDN and time will be located (as shown in FIG. 9).

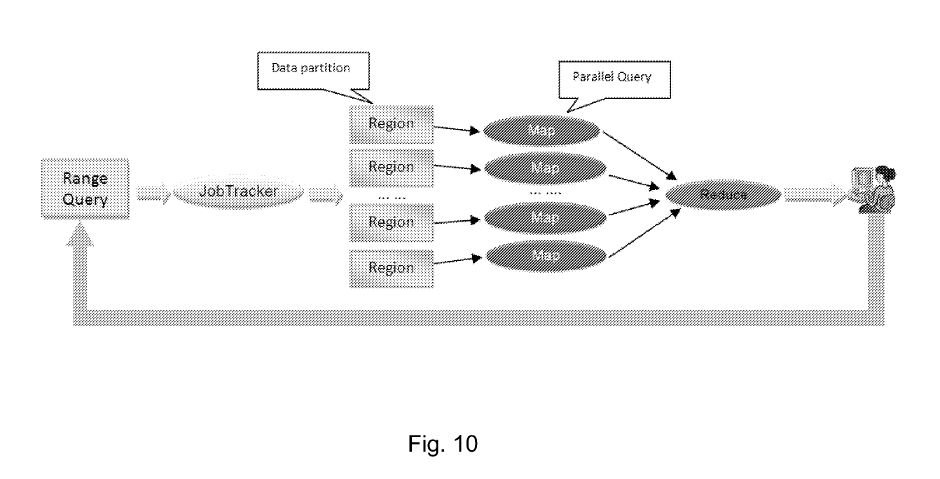

So the range query is decomposed into multiple parallel queries, and each query scans one or more regions. Map/reduce mechanism is introduced and the query is decomposed with many map tasks, and each map task corresponds to one region data. FIG. 10 shows a range query example in parallel. This query uses the rowkey generating method to get continuous rowkey values into some regions, which is similar to the data partition in FIG. 4.

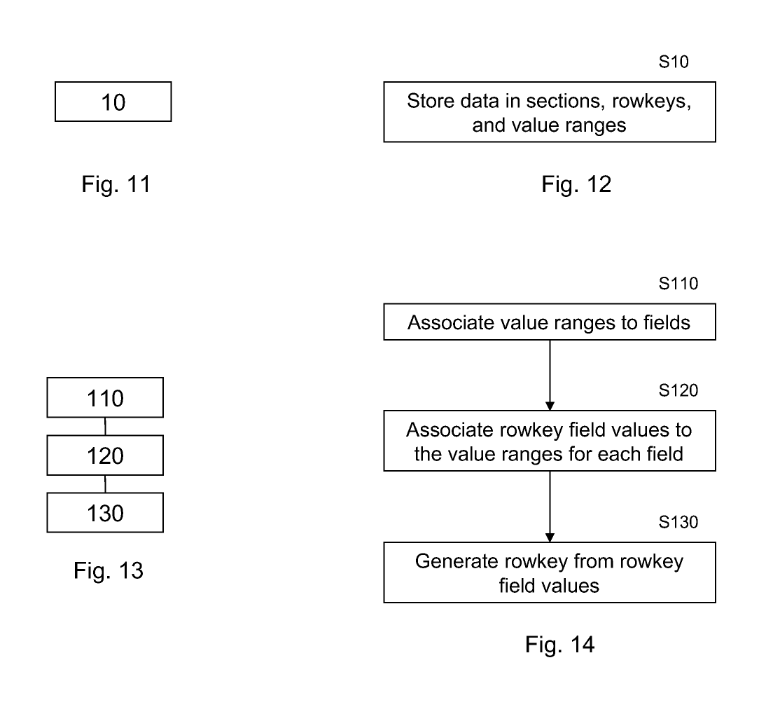

FIG. 11 shows an apparatus according to an embodiment of the invention. The apparatus may be a storing device such as a computer or a cluster of computers. FIG. 12 shows a method according to an embodiment of the invention. The apparatus according to FIG. 11 may perform the method of FIG. 12 but is not limited to this method. The method of FIG. 12 may be performed by the apparatus of FIG. 11 but is not limited to being performed by this apparatus.

The apparatus comprises storing means 10.

The storing means 10 stores sets of data in sections and stores rowkeys and value ranges (S10).

In the storing means, each set of data comprises a predefined number of fields, wherein each field of each set has a value; the rowkeys are bijectively associated to the sections; each rowkey comprises a respective rowkey field value for each of the fields, and the rowkey field values for each of the fields are continuous; each of the value ranges is associated to at least one of the fields; the rowkey field values of each of the fields are bijectively associated to the value ranges associated to the respective field; for each of the fields and for each of the sections: a first rowkey field value for the respective field of the respective section is neighbored to a second rowkey field value for the respective field of a second section of the sections, and a first value range of the respective field in the respective section is continuous with a second value range of the respective field in the second section, wherein the rowkey field values of the respective field comprise the first and second rowkey field values, and the value ranges of the respective field comprise the first and second value ranges; the storage means is adapted to store in each of the sections only those of the sets of data in which the value of each field is in the respective value range associated to the corresponding rowkey field value comprised by the rowkey associated to the respective section.

FIG. 13 shows an apparatus according to an embodiment of the invention. The apparatus may be a partitioning device for partitioning the data space in a storing apparatus such as the one of FIG. 11. FIG. 14 shows a method according to an embodiment of the invention. The apparatus according to FIG. 13 may perform the method of FIG. 14 but is not limited to this method. The method of FIG. 14 may be performed by the apparatus of FIG. 13 but is not limited to being performed by this apparatus.

The apparatus comprises value range associating means 110, rowkey field associating means 120, and rowkey generation means 130.

The value range associating means 110 associate value ranges to each of a predefined number of fields (S110). The value ranges for each of the fields are continuous.

The rowkey field value associating means 120 associates, for each of the fields, bijectively rowkey field values to the value ranges of the respective field (S120). The rowkey field values for each of the fields are continuous.

The rowkey generation means 130 generates rowkeys (S130). Each rowkey comprises one of the rowkey field values for each of the fields, and wherein a rowkey is generated for each of the corresponding combinations of the rowkey field values.

The rowkey field associating means 120 associates the rowkey field values such that for each of the fields and for each of the rowkeys: a first rowkey field value for the respective field of the respective rowkey is neighbored to a second rowkey field value for the respective field of a second rowkey of the rowkeys, and a first value range of the respective field of the respective rowkey is continuous with a second value range of the respective field of the second rowkey, wherein the rowkey field values of the respective field comprise the first and second rowkey field values, and the value ranges of the respective field comprise the first and second value ranges. Thus, for each field, if the rowkey field values are arranged such that they are continuous, the corresponding value ranges are continuous, too.

The storage apparatus may be implemented in a single hardware such as a single computer or distributed over a cluster of computers such as a grid.

Values and value ranges are considered if they are form a continuous sequence in its basic set of values. For example, sequences of natural numbers such as 1, 2, 3, or 13, 14, 15, 16, . . . are continuous in the natural numbers. Other continuous sequences are e.g. sequences of odd numbers (e.g. 11, 13, 15, 17, . . . ), sequences of even numbers (e.g. 4, 6, 8, 10, . . . ), sequences of powers of a natural number (e.g. 1, 2, 4, 8, 16, . . . ), sequences of letters (e.g. K, L, M, N, . . . ). In general, a sequence is continuous, if there are no gaps compared to the basic set and if the members of the sequence are arranged in the order of the basic set or in the reverse order. Accordingly, a neighbor of a member of a continuous sequence is a neighbor in its basic set, too.

If a field in a set of data is empty, this is considered as a specific value, too. I.e., emptiness may be one of the values of a field.

If not otherwise stated or otherwise made clear from the context, the statement that two entities are different means that they are differently addressed. It does not necessarily mean that they are based on different hardware. That is, each of the entities described in the present description may be based on a different hardware, or some or all of the entities may be based on the same hardware.

According to the above description, it should thus be apparent that exemplary embodiments of the present invention provide, for example a storage means, or a component thereof, an apparatus embodying the same, a method for controlling and/or operating the same, and computer program(s) controlling and/or operating the same as well as mediums carrying such computer program(s) and forming computer program product(s). Furthermore, it should thus be apparent that exemplary embodiments of the present invention provide, for example a partitioner, or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non limiting examples, implementations as hardware, software, firmware, special purpose circuits or logic, general purpose hardware or controller or other computing devices, or some combination thereof.

It is to be understood that what is described above is what is presently considered the preferred embodiments of the present invention. However, it should be noted that the description of the preferred embodiments is given by way of example only and that various modifications may be made without departing from the scope of the invention as defined by the appended claims.

1.-24. (canceled)

25. Apparatus, comprising:
storage means adapted to store sets of data in sections and to store rowkeys and value ranges, wherein
each set of data comprises a predefined number of fields, wherein each field of each set has a value;
the rowkeys are bijectively associated to the sections;
each rowkey comprises a respective rowkey field value for each of the fields, and the rowkey field values for each of the fields are continuous;
each of the value ranges is associated to at least one of the fields;
the rowkey field values of each of the fields are bijectively associated to the value ranges associated to the respective field;
for each of the fields and for each of the sections: a first rowkey field value for the respective field of the respective section is neighbored to a second rowkey field value for the respective field of a second section of the sections, and a first value range of the respective field in the respective section is continuous with a second value range of the respective field in the second section, wherein the rowkey field values of the respective field comprise the first and second rowkey field values, and the value ranges of the respective field comprise the first and second value ranges;
the storage means is adapted to store in each of the sections only those of the sets of data in which the value of each field is in the respective value range associated to the corresponding rowkey field value comprised by the rowkey associated to the respective section.

26. The apparatus according to claim 25, wherein the predefined number of fields is three or more.

27. The apparatus according to claim 25, further comprising
evaluating means adapted to evaluate a value of each field of a first set of data of the sets of data;
storing range determining means adapted to determine, for each field of the first set of data, the value range of the respective field, such that the value of the respective field in the first set of data falls into the determined value range;
selecting means adapted to select for each field a respective rowkey field value associated to the determined value range;
compiling means adapted to compile a first rowkey of the rowkeys, wherein the first rowkey comprises the selected rowkey field values; wherein
the storage means is adapted to store the first set of data in a first section of the sections, wherein the first section is associated to the compiled first rowkey.

28. The apparatus according to claim 27, further comprising
mapping means adapted to map the first rowkey to a first rowkey number of rowkey numbers, wherein the rowkey numbers are continuous and bijectively associated to the rowkeys, and
first identifying means adapted to identify the first section based on the first rowkey number; wherein
the storage means is adapted to store the first set of data in the first section identified by the identifying means.

29. The apparatus according to claim 28, further comprising
query range determining means adapted to determine, for each field of a query related to at least one field, one or more of the value ranges associated to the at least one field;
mapping means adapted to map the one or more determined value ranges to the associated one or more rowkey field values;
rowkey determining means adapted to determine those one or more of the rowkeys which comprise the mapped rowkey field values;
section determining means adapted to determine those one or more of the sections which are associated to the determined one or more rowkeys;
querying means adapted to perform the query in the determined one or more sections only.

30. The apparatus according to claim 29, further comprising
range identifying means adapted to identify a continuous range of rowkey numbers mapped to the determined rowkeys if more than one rowkey is determined; wherein
the querying means is adapted to perform a single query in all the sections associated to the continuous range of rowkey numbers.

31. The apparatus according to claim 29, wherein more than one section are determined and the determined sections comprise a second section and a third section different from the second section, and wherein
the querying means is adapted to perform the query in the second section in parallel to the query in the third section.

32. The apparatus according to claim 25, wherein the sections are provided in a single computer, or in different nodes of a cluster of computers.

33. Method, comprising:
storing sets of data in sections and storing rowkeys and value ranges, wherein
each set of data comprises a predefined number of fields, wherein each field of each set has a value;
the rowkeys are bijectively associated to the sections;
each rowkey comprises a respective rowkey field value for each of the fields, and the rowkey field values for each of the fields are continuous;
each of the value ranges is associated to at least one of the fields;
the rowkey field values of each of the fields are bijectively associated to the value ranges associated to the respective field;
for each of the fields and for each of the sections: a first rowkey field value for the respective field of the respective section is neighbored to a second rowkey field value for the respective field of a second section of the sections, and a first value range of the respective field in the respective section is continuous with a second value range of the respective field in the second section, wherein the rowkey field values of the respective field comprise the first and second rowkey field values, and the value ranges of the respective field comprise the first and second value ranges;
the storaging is adapted to store in each of the sections only those of the sets of data in which the value of each field is in the respective value range associated to the corresponding rowkey field value comprised by the rowkey associated to the respective section.

34. The method according to claim 33, wherein the predefined number of fields is three or more.

35. The method according to claim 33, further comprising
evaluating a value of each field of a first set of data of the sets of data;
determining, for each field of the first set of data, the value range of the respective field, such that the value of the respective field in the first set of data falls into the determined value range;
selecting for each field a respective rowkey field value associated to the determined value range;
compiling a first rowkey of the rowkeys, wherein the first rowkey comprises the selected rowkey field values; wherein
the storing is adapted to store the first set of data in a first section of the sections, wherein the first section is associated to the compiled first rowkey.

36. The method according to claim 35, further comprising
mapping the first rowkey to a first rowkey number of rowkey numbers, wherein the rowkey numbers are continuous and bijectively associated to the rowkeys, and
identifying the first section based on the first rowkey number; wherein
the storing is adapted to store the first set of data in the identified first section.

37. The method according to claim 36, further comprising
determining, for each field of a query related to at least one field, one or more of the value ranges associated to the at least one field;
mapping the one or more determined value ranges to the associated one or more rowkey field values;
determining those one or more of the rowkeys which comprise the mapped rowkey field values;
determining those one or more of the sections which are associated to the determined one or more rowkeys;
performing the query in the determined one or more sections only.

38. The method according to claim 37, further comprising
identifying a continuous range of rowkey numbers mapped to the determined rowkeys if more than one rowkey is determined; wherein
the query is performed as a single query in all the sections associated to the continuous range of rowkey numbers.

39. The method according to claim 37, wherein more than one section are determined and the determined sections comprise a second section and a third section different from the second section, and wherein
the query in the second section is performed in parallel to the query in the third section.

40. The method according to claim 33, wherein the sections are provided in a single computer, or in different nodes of a cluster of computers.

41. Method, comprising:
associating value ranges to each of a predefined number of fields, wherein the value ranges for each of the fields are continuous;
associating, for each of the fields, bijectively rowkey field values to the value ranges of the respective field, wherein the rowkey field values for each of the fields are continuous;
generating rowkeys, wherein each rowkey comprises one of the rowkey field values for each of the fields, and wherein a rowkey is generated for each of the corresponding combinations of the rowkey field values; wherein
the associating of the rowkey field values is further adapted to associate the rowkey field values such that for each of the fields and for each of the rowkeys:
a first rowkey field value for the respective field of the respective rowkey is neighbored to a second rowkey field value for the respective field of a second rowkey of the rowkeys, and a first value range of the respective field of the respective rowkey is continuous with a second value range of the respective field of the second rowkey, wherein the rowkey field values of the respective field comprise the first and second rowkey field values, and the value ranges of the respective field comprise the first and second value ranges.

42. The method according to claim 41, further comprising
associating bijectively the rowkeys to sections of a storage device.

43. A computer program product embodied on a non-transitory computer-readable medium, said product comprising a set of instructions which, when executed on an apparatus, is configured to cause the apparatus to carry out the method according to claim 33.
